(19) United States
(12) Patent Application Publication
(10) Pub. No.: US 2023/0039032 A1
(43) Pub. Date: Feb. 9, 2023

(54) APPARATUS AND METHOD FOR UPDATING MAP AND NON-TRANSITORY COMPUTER-READABLE MEDIUM CONTAINING COMPUTER PROGRAM FOR UPDATING MAP

(71) Applicant: TOYOTA JIDOSHA KABUSHIKI KAISHA, Toyota-shi (JP)

(72) Inventor: Masahiro Tanaka, Tokyo-to (JP)

(21) Appl. No.: 17/812,517

(22) Filed: Jul. 14, 2022

(30) Foreign Application Priority Data
Aug. 4, 2021 (JP) 2021-128538

(51) Int. Cl. G01C 21/00

(52) U.S. Cl. CPC G01C 21/3822; G01C 21/3811; G01C 21/3833

(57) ABSTRACT

An apparatus for updating a map detects the positions of reference points corresponding to a feature on a road being traveled by a vehicle from surrounding data representing features around the vehicle, and updates probability distributions associated with the respective reference points so that the probabilities of existence of the reference points at the detected positions of the reference points increase. Each of the probability distributions indicates the probability of existence of the corresponding reference point as a function of position.

### FIELD

The present disclosure relates to an apparatus, a method, and a computer program for updating a map, based on surrounding data representing features around a vehicle.

### BACKGROUND

High-precision maps to which an autonomous vehicle-driving system refers for autonomous driving control of a vehicle are required to accurately represent information on those features on or around roads which relate to travel of vehicles, such as lane lines. Thus, a technique to collect data representing features from vehicles actually traveling on roads has been proposed.

For example, Japanese Unexamined Patent Publication No. 2011-017989 (hereafter, “Patent Literature 1”) describes a device for evaluating the reliability of a value related to a feature included in map information (evaluation object value). The device described in Patent Literature 1 obtains measurement values for measuring an evaluation object value with a sensor, selects a method for evaluating reliability, depending on the variance of the measurement values, and evaluates the reliability of the evaluation object value by the selected method.

### SUMMARY

A sensor mounted on a vehicle cannot always detect all the features around the vehicle appropriately. In other words, only some of the features around the vehicle may be detected from data generated by the sensor. In this case, update of map information based on only the detected features may lead to inconsistency in the map information, such as discontinuity of a lane line.

It is an object of the present disclosure to provide an apparatus for updating a map that can improve the positional accuracy of a feature represented in the map.

The apparatus for updating a map according to the present disclosure includes a processor configured to detect the positions of reference points corresponding to a feature on a road being traveled by a vehicle from surrounding data representing features around the vehicle, and to update probability distributions associated with the respective reference points so that the probabilities of existence of the reference points at the detected positions of the reference points increase. Each of the probability distributions indicates the probability of existence of the corresponding reference point as a function of position.

The processor of the apparatus according to the present disclosure preferably further generates a map for delivery including one of the reference points at which a variance of the probability distribution associated therewith is less than a variance threshold, and delivers the generated map to a vehicle.

Preferably, in the apparatus according to the present disclosure, the feature is a lane line demarcating a lane; and the reference points are positioned on the lane line at predetermined intervals with respect to a predetermined location.

Preferably, the lane line is one of a pair of lane lines demarcating one of lanes of interest; and in the case that the position of a reference point is detected on the one of the lane lines from the surrounding data and that no reference point is detected on the other of the lane lines demarcating the one of lanes, the processor of the apparatus according to the present disclosure updates a probability distribution associated with a reference point on the other lane line, by using a position a distance of a width associated with the one of lanes away from the position of the one of the lane lines as a reference point on the other lane line.

Preferably, when it is determined that, of the positions of one of the reference points detected from pieces of surrounding data representing features around the vehicle, the positions of the reference point detected from at least a predetermined number of pieces of surrounding data significantly differs from a probability distribution associated with the reference point, the processor of the apparatus according to the present disclosure updates the probability distribution associated with the reference point.

A method for updating a map according to the present disclosure includes detecting the positions of reference points corresponding to a feature on a road being traveled by a vehicle from surrounding data representing features around the vehicle; and updating probability distributions associated with the respective reference points so that the probabilities of existence of the reference points at the detected positions of the reference points increase. Each of the probability distributions indicates the probability of existence of the corresponding reference point as a function of position.

A computer program for updating a map stored in a non-transitory computer-readable medium according to the present disclosure causes a computer to execute a process including detecting the positions of reference points corresponding to a feature on a road being traveled by a vehicle from surrounding data representing features around the vehicle; and updating probability distributions associated with the respective reference points so that the probabilities of existence of the reference points at the detected positions of the reference points increase. Each of the probability distributions indicates the probability of existence of the corresponding reference point as a function of position.

The apparatus according to the present disclosure can improve the positional accuracy of a feature represented in the map.

### BRIEF DESCRIPTION OF DRAWINGS

FIG. 1 illustrates the hardware configuration of an apparatus for updating a map.

FIG. 2 is a functional block diagram of a processor included in the apparatus for updating a map.

FIG. 3 is a schematic diagram for explaining update of a reliability distribution.

FIG. 4 is a flowchart of a map update process.

### DESCRIPTION OF EMBODIMENTS

An apparatus for updating a map that can improve the positional accuracy of a feature represented in the map will now be described in detail with reference to the attached drawings. The apparatus updates a map stored in a storage device, using surrounding data representing features around a vehicle. The map has reference points corresponding to a feature on a road, each of which is associated with a probability distribution indicating the probability of existence of the reference point as a function of position. The apparatus detects the position of a reference point from surrounding data, and updates the probability distribution associated with the reference point so that the probability of existence of the reference point at the detected position of the reference point increases.

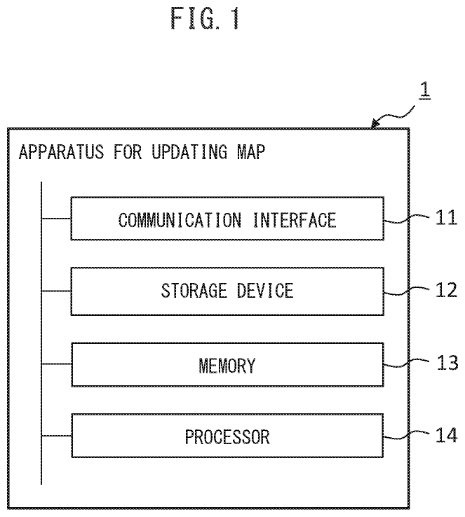

FIG. 1 illustrates the hardware configuration of the apparatus 1 for updating a map. The apparatus 1 includes a communication interface 11, a storage device 12, a memory 13, and a processor 14.

The communication interface 11, which is an example of a communication unit, includes an interface circuit for connecting the apparatus 1 to a communication network. The communication interface 11 is configured so that it can communicate with another device via the communication network. More specifically, the communication interface 11 passes to the processor 14 data received from a device via the communication network, and transmits data received from the processor 14 to a device via the communication network.

The storage device 12, which is an example of a storage unit, includes storage, such as a hard disk drive or a nonvolatile semiconductor memory. The storage device 12 contains a map including reference points corresponding to a feature on a road.

The reference points are set so as to correspond to a feature to indicate its position. For example, to indicate the position of a lane line, a reference point is set at a predetermined location, such as an intersection, in the map. Additionally, points on the lane line positioned at predetermined intervals (e.g., 10 m) with respect to such a predetermined location are set in the map as reference points. The predetermined intervals are not limited to regular intervals; the only requirement is that the distance from a predetermined location to a reference point is determined in advance.

For each reference point, the storage device 12 also contains a probability distribution indicating the probability of existence of the reference point as a function of position (hereafter, a “reliability distribution”). The reliability distribution may be a normal distribution corresponding to a position on a two-dimensional plane along a road surface or in a three-dimensional space.

The memory 13 includes volatile and nonvolatile semiconductor memories. The memory 13 temporarily contains various types of data used for processing by the processor 14, such as data received via the communication interface 11. The memory 13 also contains various application programs, such as a map update program for updating the map stored in the storage device 12.

The processor 14 includes one or more central processing units (CPUs) and a peripheral circuit thereof. The processor 14 may further include another operating circuit, such as a logic-arithmetic unit or an arithmetic unit.

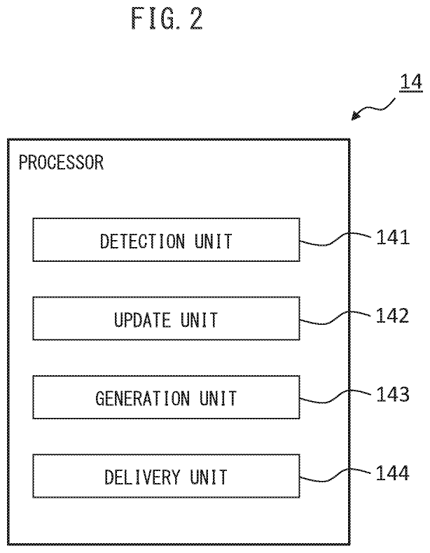

FIG. 2 is a functional block diagram of the processor 14 included in the apparatus 1.

As its functional blocks, the processor 14 of the apparatus 1 includes a detection unit 141, an update unit 142, a generation unit 143, and a delivery unit 144. These units included in the processor 14 are functional modules implemented by a computer program executed by the processor 14. The computer program for achieving the functions of the units of the processor 14 may be provided in a form recorded on a computer-readable and portable medium, such as a semiconductor memory, a magnetic medium, or an optical medium. Alternatively, the units included in the processor 14 may be implemented in the apparatus 1 as separate integrated circuits, microprocessors, or firmware.

The detection unit 141 detects the positions of reference points corresponding to a feature on a road being traveled by a vehicle (not shown) from surrounding data representing features around the vehicle.

The vehicle is equipped with a surround capturing camera that captures the surroundings of the vehicle and that outputs surrounding data. The vehicle is equipped with an electronic control unit (ECU) that obtains surrounding data from the surround capturing camera and that transmits the surrounding data to the apparatus 1 via a communication network including a wireless base station.

The vehicle may record the surrounding data on a computer-readable and portable medium. The apparatus 1 can obtain the surrounding data by reading the medium with a media reader (not shown) connected to the communication interface 11.

The detection unit 141 inputs the surrounding data into a classifier that has been trained to identify features on a road, such as lane lines, thereby detecting the position of a feature on a road. For each feature represented in the map, the detection unit 141 calculates the distance from the position where the reliability of the feature represented in the map is highest, i.e., the position of the average of the reliability distribution, to the position of the feature detected from the surrounding data. The detection unit 141 then associates the feature detected from the surrounding data with one of the features represented in the map whose calculated distance is shortest and not greater than a predetermined distance threshold and whose type is the same as that of the feature detected from the surrounding data.

The classifier may be, for example, a convolutional neural network (CNN) including convolution layers connected in series from the input toward the output. A CNN that has been trained in accordance with a predetermined training technique, such as backpropagation, using images including detection target features on a road as training data operates as a classifier to detect features on a road.

Regarding reference points on a lane line, the detection unit 141 detects the positions of the lane line at a predetermined location and at locations positioned at predetermined intervals with respect to the predetermined location as the positions of the reference points, based on the position of the vehicle corresponding to the surrounding data.

The update unit 142 updates the reliability distributions, which are respectively associated with reference points in the map stored in the storage device 12, so that the probabilities of existence of the reference points at the detected positions of the reference points increase.

The update unit 142 updates the reliability distributions by maximum likelihood estimation. The update unit 142 divides an area in the region included in the map where a reference point may exist into multiple divisions, and counts, for each division, the number of times of detection of a reference point. For each division, the update unit 142 then divides the number of times of detection of a reference point in the division by the total number of times of detection of a reference point in any division, thereby making a reliability distribution indicating the probability of existence of a reference point. When a reliability distribution corresponding to a position on a two-dimensional plane is made, the divisions are set in a grid pattern. The probability of existence of a reference point at the position of a newly detected reference point is higher in a reliability distribution calculated in response to detection of the reference point than in a reliability distribution before the update.

The update unit 142 may update the reliability distributions by Bayesian updating. More specifically, the update unit 142 divides a predetermined area around a reference point in the region included in the map into multiple divisions, and sets, for each division, reliability indicating the probability of existence of the reference point in the division. As the initial values of the reliability of the respective divisions, the same value may be set for each division, or a higher value may be set for a division where the reference point is more likely to exist. Upon detection of the position of a reference point from the surrounding data, the update unit 142 updates the reliability of each division so that the reliability of the division including the detected position of the reference point increases. Alternatively, the update unit 142 may update the reliability of each division so that the reliability of divisions within a predetermined area around the position of the reference point indicated by the surrounding data increases. To this end, the update unit 142 may increase the reliability of a division closer to the position of the reference point at a higher rate. The update unit 142 calculates an updated reliability distribution of the position of the reference point by approximating the reliability of each division with a normal distribution, and stores the reliability distribution in the storage device 12.

Alternatively, for each reference point, the update unit 142 may set candidates for the reliability distribution of the position of the reference point. In this case, each candidate may be a normal distribution represented by an average position and a variance-covariance matrix. The update unit 142 calculates the posterior probabilities of the respective candidates regarding the position of the reference point indicated by the surrounding data, and uses the posterior probabilities as the prior probabilities of the respective candidates at the next update. The update unit 142 determines the normal distribution corresponding to the candidate whose prior probability is the highest as the reliability distribution of the position of the reference point.

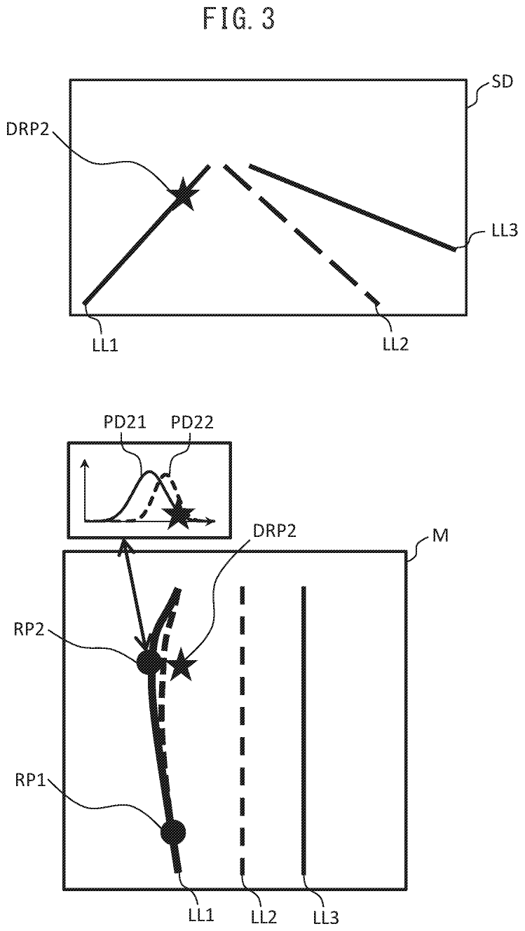

FIG. 3 is a schematic diagram for explaining update of a reliability distribution.

Surrounding data SD represents lane lines LL1, LL2, and LL3. From the surrounding data SD, the detection unit 141 detects a location a predetermined distance away from a predetermined location on the lane line LL1 as a reference point DRP2.

Of the lane lines LL1, LL2, and LL3 included in a map M, the lane line LL1 has reference points RP1 and RP2 separated by a predetermined distance. The reference points RP1 and RP2 are each associated with a reliability distribution; the prior distribution corresponding to the reference point RP2 is represented by a reliability distribution PD21. In the reliability distribution, the abscissa represents the lateral position of the road whereas the ordinate represents the probability that a reference point is detected at the corresponding position.

In the example of FIG. 3, the reference point DRP2 detected from the surrounding data SD is positioned on the right of the reference point RP2 set in the map M. The apparatus 1 updates the reliability distribution PD21 associated with the reference point RP2 to a reliability distribution PD22 such that the probability of existence of the reference point RP2 at the position of the reference point DRP2 increases.

The update unit 142 may determine whether, of the positions of one of the reference points detected from pieces of surrounding data, the positions of the reference point detected from at least a predetermined number of pieces of surrounding data significantly differs from a reliability distribution associated with the reference point. In this case, when it is determined that the detected positions of the reference point significantly differs from the reliability distribution associated with the reference point, the update unit 142 updates the probability distribution associated with the reference point.

The generation unit 143 generates a map for delivery including a reference point at which a variance of the reliability distribution associated therewith is less than a variance threshold prestored in the memory 13, of the reference points included in the map stored in the storage device 12. The variance threshold may be set for each direction of variances of a reliability distribution corresponding to a two-dimensional plane or a three-dimensional space. The generation unit 143 may store the generated map in the storage device 12.

The delivery unit 144 delivers the map generated by the generation unit 143 to a vehicle via the communication interface 11 and the communication network. An autonomous driving system of the vehicle controls the vehicle to automatically drive it, using the delivered map.

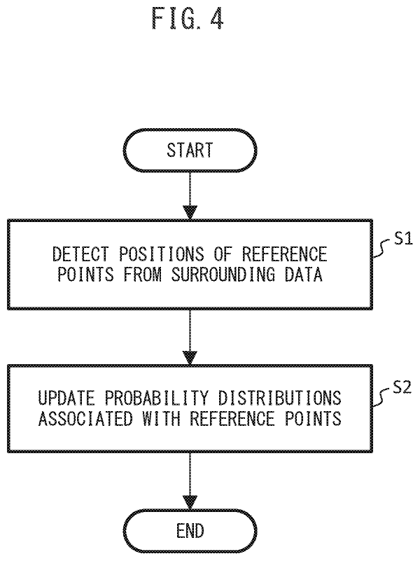

FIG. 4 is a flowchart of a map update process. The processor 14 of the apparatus 1 executes the map update process illustrated in FIG. 4 whenever receiving surrounding data to be processed. The processor 14 of the apparatus 1 may execute the map update process illustrated in FIG. 4 whenever receiving two or more predetermined number of pieces of surrounding data.

First, the detection unit 141 of the processor 14 detects the positions of reference points corresponding to a feature on a road being traveled by a vehicle from surrounding data representing features around the vehicle (step S1).

Next, the update unit 142 of the processor 14 updates reliability distributions associated with the respective reference points so that the probabilities of existence of the reference points at the detected positions of the reference points increase (step S2); and then it terminates the map update process.

Such a map update process enables the apparatus 1 to improve the positional accuracy of a feature represented in the map.

In some cases, the position of a reference point is detected by the detection unit 141 on one of a pair of lane lines demarcating one of lanes of interest from surrounding data, and no reference point is detected on the other of the lane lines demarcating the one of lanes. According to a modified example, the update unit 142 then updates a probability distribution associated with a reference point on the other lane line, assuming that a reference point on the other lane line is detected at a position a distance of a width associated with the one of lanes away from the position of the one of the lane lines. The width may be prestored in the storage device 12 in association with the lane. When updating the probability distributions by Bayesian updating, the update unit 142 may represent the likelihood of the reference point assumed to be detected on the other lane line as a normal distribution whose average is at a position a distance of the width away from the position of the reference point detected on the one of the lane lines and whose variance in the direction perpendicular to the other lane line is not less than a half of the width. Even if no reference point is detected on one of a pair lane lines, the positional accuracy of a feature represented in the map can be improved by updating the map in this way, using the width and the position of a detected reference point on the other of the lane lines.

Note that those skilled in the art can apply various changes, substitutions, and modifications without departing from the spirit and scope of the present disclosure.

What is claimed is:

1. An apparatus for updating a map, comprising a processor configured to:
detect the positions of reference points corresponding to a feature on a road being traveled by a vehicle from surrounding data representing features around the vehicle; and
update probability distributions associated with the respective reference points so that the probabilities of existence of the reference points at the detected positions of the reference points increase, each of the probability distributions indicating the probability of existence of the corresponding reference point as a function of position.

2. The apparatus according to claim 1, wherein the processor is further configured to:
generate a map for delivery including one of the reference points at which a variance of the probability distribution associated therewith is less than a variance threshold: and
deliver the generated map to a vehicle.

3. The apparatus according to claim 1, wherein the feature is a lane line demarcating a lane; and the reference points are positioned on the lane line at predetermined intervals with respect to a predetermined location.

4. The apparatus according to claim 3, wherein the lane line is one of a pair of lane lines demarcating one of lanes of interest; and in the case that the position of a reference point is detected on the one of the lane lines from the surrounding data and that no reference point is detected on the other of the lane lines demarcating the one of lanes, the processor updates a probability distribution associated with a reference point on the other lane line, by using a position a distance of a width associated with the one of lanes away from the position of the one of the lane lines as a reference point on the other lane line.

5. The apparatus according to claim 1, wherein when it is determined that, of the positions of one of the reference points detected from pieces of surrounding data representing features around the vehicle, the positions of the reference point detected from at least a predetermined number of pieces of surrounding data significantly differs from a probability distribution associated with the reference point, the processor updates the probability distribution associated with the reference point.

6. A method for updating a map, comprising:
detecting the positions of reference points corresponding to a feature on a road being traveled by a vehicle from surrounding data representing features around the vehicle; and
updating probability distributions associated with the respective reference points so that the probabilities of existence of the reference points at the detected positions of the reference points increase, each of the probability distributions indicating the probability of existence of the corresponding reference point as a function of position.

7. A non-transitory computer-readable medium containing a computer program for updating a map, the computer program causing a computer to execute a process comprising:
detecting the positions of reference points corresponding to a feature on a road being traveled by a vehicle from surrounding data representing features around the vehicle; and
updating probability distributions associated with the respective reference points so that the probabilities of existence of the reference points at the detected positions of the reference points increase, each of the probability distributions indicating the probability of existence of the corresponding reference point as a function of position.
